(19) United States
(12) Patent Application Publication
(10) Pub. No.: US 2009/0061665 A1
(43) Pub. Date: Mar. 5, 2009

(54) Powered external serial advancement technology attachment socket

(75) Inventor: Jui-Tu Chiang, Jhonghe City (TW)

Correspondence Address: ELIZABETH CHIEN-HALE, 40087 MISSION BLVD. BOX 367, FREMONT, CA, 94539, US

(73) Assignee: Taiwan Electronics Co., LTD.

(21) Appl. No.: 11/899,311

(22) Filed: Sep. 4, 2007

(51) Int. Cl. H01R 13/648

(52) U.S. Cl. 439/99

(57) ABSTRACT

A powered external serial advancement technology attachment (eSATA) socket has a front and a chamber formed in the front of the socket and having multiple eSATA terminals and a power supply assembly. The eSATA terminals are formed on and protrude from the inner surface of the chamber. The power supply assembly has multiple feet formed on and protruding from the inner surface of the chamber and connected electrically to a power source. Therefore, supplementary power wires or plugs are unnecessary when using the powered eSATA socket that is therefore more convenient and promotes widespread application of eSATA technology.

### BACKGROUND OF THE INVENTION

1. Field of the Invention

The present invention relates to a connector, and more particularly to a powered external serial advanced technology attachment connector with high translating capacity and being capable of supplying power.

2. Description of Related Art

Translation cables are connected between electronic devices such as computers, notebooks, personal digital assistants, digital cameras and the like and peripheries for electronic devices such as digital cameras, printers, storage devices, hard drives and the like for translating digital data between electronic devices and peripheries. The electronic device has a translation connector socket. The periphery may have a translation connector socket. The translation cable has at least one translation connector plug corresponding to and mounted removably in the translation connector socket of the electronic device and is connected electrically to the periphery. The translation cable may be formed on and extend from the periphery or further comprise another translation connector plug that corresponds to and is mounted removably in the translation connector socket of the periphery. Currently, the most widely used connectors for digital data translation are universal serial bus (USB), USB 2.0 and Firewire. USB connection systems are ubiquitously utilized and are capable of translation speeds up to around 480 Mbps per second.

However, as electronic devices and peripheries require ever greater data transfer and translation connectors with higher speed translation technology is becoming increasingly desirable.

External serial advanced technology attachment (eSATA) connectors have translations speeds around 1.5 Gbps per second. With reference to FIGS. 3 and 4, an eSATA socket (60) has a front and a chamber (61) formed in the front. The chamber (61) has an inner surface having a top and multiple terminals (62) separately protruding from the top of the inner surface of the chamber (61) and electrically connected to a corresponding plug inserting in the chamber (61). However current eSATA sockets (60) are incapable of supplying power to peripheries. Therefore, the peripheries require two connectors, one supplying power and another transferring data, thereby causing great inconvenience to a user and preventing this technology from gaining widespread use.

To overcome the shortcomings, the present invention provides a powered eSATA socket to obviate or mitigate the aforementioned problems.

### SUMMARY OF THE INVENTION

The main objective of the present invention is to provide a powered external serial advancement technology attachment (eSATA) socket with high translating capacity and being capable of supplying power thereby increasing convenience of use.

To achieve the objective, the eSATA socket comprises a front and a chamber formed in the front of the socket and having multiple eSATA terminals and a power supply assembly. The eSATA terminals are formed on and protrude from the inner surface of the chamber. The power supply assembly comprises multiple feet formed on and protruding from the inner surface of the chamber and connected electrically to a power source. Therefore, supplementary power wires or plugs are unnecessary when using the powered eSATA socket that is therefore more convenient and promotes widespread application of eSATA technology.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a powered external serial advancement technology attachment (eSATA) socket in accordance with the present invention;

FIG. 2 is a front view of the powered eSATA socket in FIG. 1;

FIG. 3 is a perspective view of a conventional eSATA socket in accordance with prior art; and

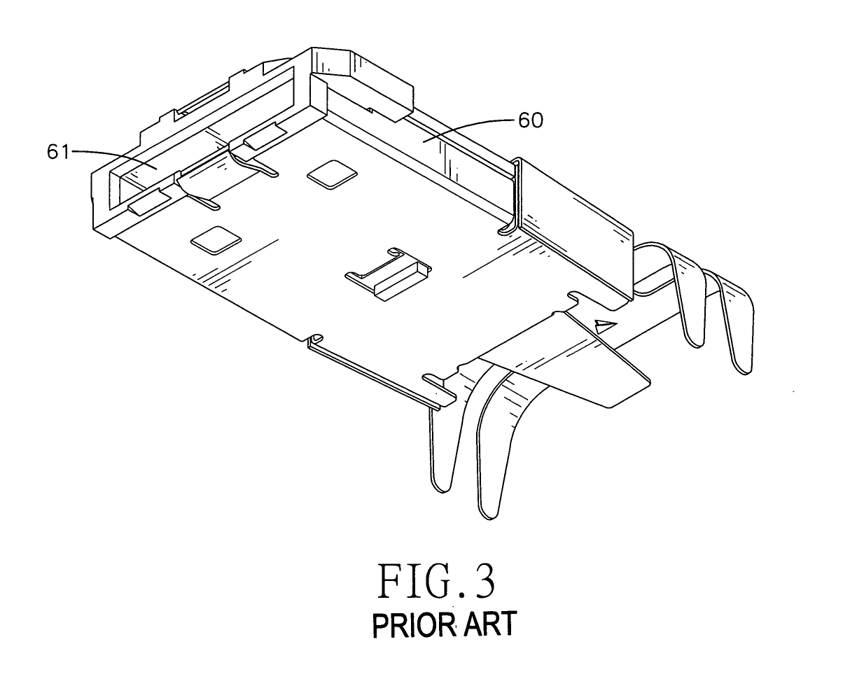

FIG. 4 is a front view of the eSATA socket in FIG. 3.

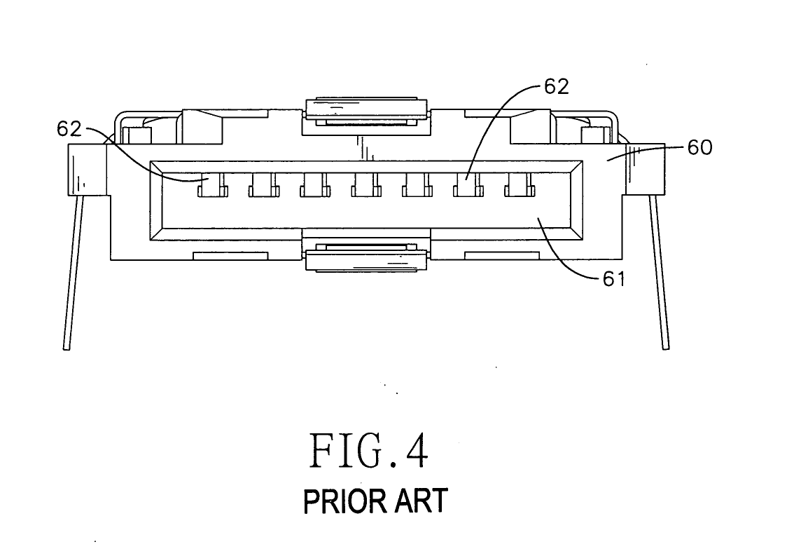

### DETAILED DESCRIPTION OF THE PREFERRED EMBODIMENT

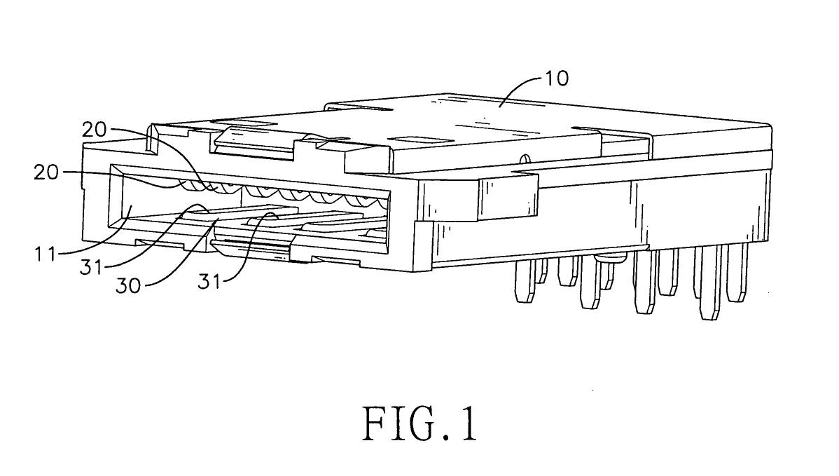

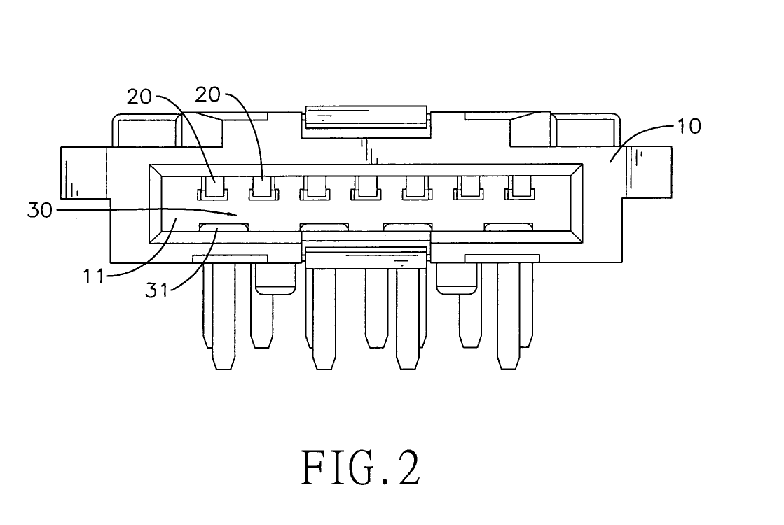

With reference to FIGS. 1 and 2, the powered eSATA socket in accordance with present invention is connected electrically to an electronic device such as a computer, mobile phone, personal digital assistant, computer periphery or the like and comprises a body (10), multiple eSATA-terminals (20) and a power supply assembly (30) and allows a periphery such as a computer, mobile phone, personal digital assistant, computer periphery, printer, modem, translation cable or the like to be connected electrically to the electronic device.

The body (10) has a front and a chamber (11). The chamber (11) is formed in the front of the body (10), has an inner surface having a top and a bottom and corresponds to an eSATA plug of the periphery.

The eSATA-terminals (20) are formed on and protrude from the top of the inner surface of the chamber (11) and electrically connected to the electronic device.

The power supplying assembly (30) comprises multiple feet (31). The feet (31) are formed on and protrude from the inner surface of the chamber (11), and are connected electrically to a power source A preferred embodiment comprises four feet (31) formed from and protruding from the bottom inner surface of the chamber (20), wherein two of the feet (31) are sensors to detect the existence of the plug in the chamber (11) and enable power transmission through the feet (31).

The eSATA plug is adapted to correspond to and is mounted removably in the eSATA socket to allow electronic devices connected with the eSATA plug and socket to be powered by the power supplying assembly (30). Therefore, supplementary power wires or plugs are unnecessary.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

1. A powered external serial advanced technology attachment (eSATA) socket comprising
a body having
a front; and
a chamber being formed in the front of the body and having an inner surface having a top and a bottom;
multiple seven eSATA-terminals being formed on and protruding from the top of the inner surface of the chamber; and
a power supplying assembly comprising multiple feet being formed on and protruding from the bottom of the inner surface of the chamber for conducting electricity and being adapted to connect electrically to a power source.

2. The powered eSATA socket as claimed in claim 1, wherein the power supplying assembly comprises four feet.

3. The powered eSATA socket as claimed in claim 2, wherein two of the feet are sensors to detect the existence of an eSATA plug in the chamber and enable power transmission.

4. (canceled)
